(19) United States
(12) Patent Application Publication
(10) Pub. No.: US 2009/0232701 A1
(43) Pub. Date: Sep. 17, 2009

(54) Robotic Pool Cleaner with Internal Ultraviolet Water Sterilization

(75) Inventor: Joseph Porat, Delray Beach, FL (US)

Correspondence Address: ABELMAN, FRAYNE & SCHWAB, 666 THIRD AVENUE, 10TH FLOOR, NEW YORK, NY, 10017, US

(73) Assignee: AQUATRON INC., Delray Beach, FL (US)

(21) Appl. No.: 12/227,395

(22) PCT Filed: May 17, 2007
(86) PCT No.: PCT/US2007/012070

§ 371 Date: Nov. 13, 2008

Related U.S. Application Data
(60) Provisional application No. 60/801,507, filed on May 17, 2006.

(51) Int. Cl. B01J 19/12

(52) U.S. Cl. 422/24; 422/186.3

(57) ABSTRACT

A pool cleaning apparatus for cleaning the bottom and sidewalls of a swimming pool has an exterior housing through which water is circulated and at least one source of water-sterilizing ultraviolet (UV) radiation in the form of a straight,—circular and/or curvilinear tube that is positioned on the interior of the housing so that the amount of any bacteria in the water circulated past the UV radiation source is reduced.

### FIELD OF THE INVENTION

This invention relates to robotic pool cleaners having self-contained water sterilization capabilities.

### BACKGROUND OF THE INVENTION

It is known that ultraviolet, or UV, light sources have the capability of killing bacteria. Ultraviolet light sources can be in the form of straight and circular tubes and can be powered by 12 to 24-volt power systems.

It is also known that UV light can be harmful to the human eye and that such exposure should be extremely limited.

There are various methods for treating water in swimming pools to reduce the bacteria count to ensure the health and safety of those using the pool. The most common disinfectant is chlorine which can be added as a dry chemical through the swimming pool's water circulation system. Alternatively, chlorine ions can be added using an electrochemical apparatus in which the chlorine is generated by the disassociation of sodium chloride that is added to the pool in relatively small quantities.

Treatment of the pool's water using ozone generated by an electrochemical process is also known.

The use of on-board devices that are secured to a robotic pool cleaner to generate chlorine and ozone as the pool cleaner traverses the bottom and/or sidewalls of a pool during its cleaning cycle have been disclosed. Since a substantial volume of water is drawn through the particulate filter system inside of the pool cleaner housing and passed through its outlet port, it would be advantageous to provide additional means for further disinfecting the filtered water as it passes through the housing.

It is therefore a principal object of the present invention to provide a novel means for disinfecting the water while it is on the interior of the pool cleaner housing.

It is another object of the invention to provide an apparatus and method for treating swimming pool water using a source of ultraviolet radiation that is safe and that does not present a risk of exposure to users of the swimming pool.

It is a further object of the invention to provide a source of ultraviolet radiation that is effective and yet protected from damage by inadvertent contact with users of the pool and/or recreational equipment and toys that are being used in and around the pool.

### SUMMARY OF THE INVENTION

The above objects and other advantages are obtained by incorporating one or more sources of ultraviolet radiation that are on the inside of a pool cleaner housing and positioned so that the UV radiation is directed toward water that is passing through the pool cleaner housing during the cleaning cycle. The sources of UV radiation can include one or more straight or curvilinear tubes, e.g., circular tubes that are secured in appropriate waterproof housings to the interior surface of the pool cleaner housing. The tubes can also be secured to a waterproof housing for a drive motor, a pump or a chlorine generator unit, electrically connected to a power source inside of the housing or cover. In the case of battery-powered units, the UV radiation source can be electrically connected to the battery housing.

In a preferred embodiment, the tubes are provided with an appropriate reflector or barrier to minimize the exposure of the interior of the housing to the UV radiation source at close range.

In an especially preferred embodiment, the water passing through the housing is channeled to move in close proximity to the radiation source to enhance the bactericidal effectiveness of the exposure.

The UV light source is preferably installed in a transparent waterproof protective housing that includes any necessary circuitry and circuit elements to provide the required power characteristics to activate the radiation source. The tube is preferably provided with a standard socket member for receiving a power plug. Power can be provided by an on-board rechargeable battery or from a power supply unit located outside of the pool and delivered via the pool cleaner's power cord.

The appropriate protective shielding to prevent deterioration of the interior surface of the pool cleaner housing can be provided in any number of ways known to the art. For example, the interior of the housing can be sprayed with an appropriate UV resistant coating subsequent to its manufacture and before installation of other components. The UV tube itself can be provided with an appropriate reflector by chemical deposition and/or mechanical shielding applied to the exterior of the tube. Mechanical shielding in the form of an adhesively bonded layer or film of UV barrier material can be applied to the interior of the housing.

A further alternative is to fabricate the pool cleaner housing from a plastic composition that has been especially formulated to provide enhanced UV radiation resistance. As a general rule, the plastics conventionally used to manufacture these housings do have a reasonably high resistance to UV radiation from exposure to the sun.

Various forms and shapes of mechanical baffles and/or barriers can be installed to form channels However, as will be recognized by one of ordinary skill in the art, such mechanical barriers should not present obstacles to the flow of water as to create turbulence and frictional losses that will detract from the overall cleaning efficiency of the unit.

The pool cleaner equipped in accordance with the invention is preferably provided with a water sensing switch so that power to the UV radiation source is turned off when the unit is removed from the water and/or when the pump is turned off and water is not moving through the housing.

### BRIEF DESCRIPTION OF THE DRAWINGS

The invention will be further described with reference to the attached drawings in which the same or similar elements are identified by the same numbers, and in which:

FIG. 1 is a sectional side elevation view of a pool cleaner housing with certain of its components removed for simplicity and shown partly in phantom illustrating one embodiment of the invention;

FIG. 2 is a view similar to FIG. 1 showing a second embodiment of the invention;

FIG. 3 is a schematic illustration of an electrical circuit illustrating several alternatives suitable for use with the embodiments of FIGS. 1 and 2.

FIG. 4 is a perspective view of a typical waterproof motor housing fitted with UV radiation sources in one configuration;

FIG. 5 is a view similar to FIG. 4 illustrating another configuration of UV radiation sources secured to the housing;

FIG. 6 is a schematic illustration, partly in section, showing yet another embodiment of the invention;

FIG. 6A is an enlarged view of a portion of the apparatus constructed in accordance with the invention;

FIG. 7 is another schematic illustration, partly in section, illustrating another embodiment employing a circular UV tube secured to the pump motor housing;

FIG. 7A is an enlarged view of a portion of the apparatus constructed in accordance with the invention; and

FIG. 8 is a schematic illustration, partly in section, showing an installation of the embodiment of FIG. 5

### DETAILED DESCRIPTION OF THE INVENTION

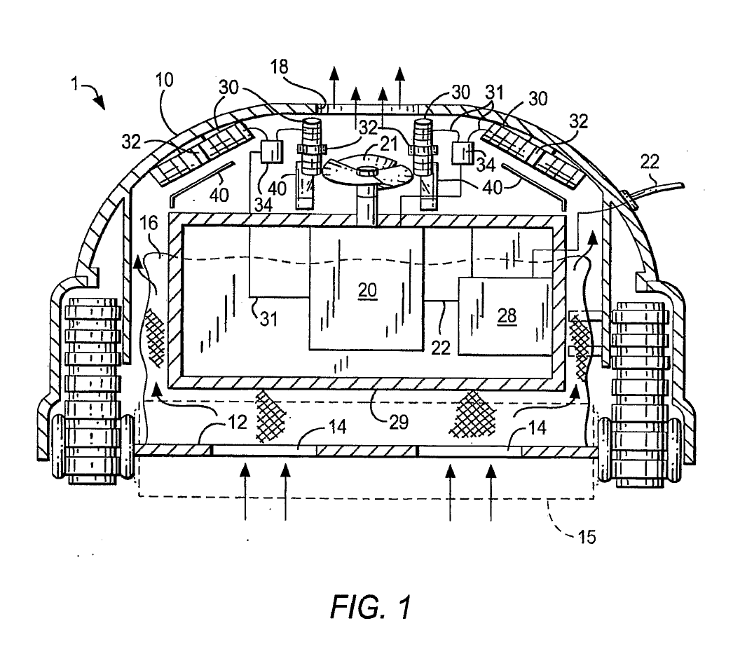

Referring to FIG. 1, the pool cleaner housing 10 is of a typical configuration known in the art and is fitted with a base plate 12 having water inlet openings 14 through which water is drawn for passage through a filter bag 16 and discharged through outlet opening 18 in the upper portion of the housing. A pump 20 has an impeller 21 for moving the water drawn through the base plate 12 for eventual discharge from the housing. The pump motor receives power from a power cord 22 that is connected either to batteries or an external power source (not shown) both of which are conventional and well known in the art.

In this embodiment, several vertical UV radiation sources in the form of straight tubes 30 are mounted on the interior surface of the pool cleaner housing using appropriate fittings 32. The tubes can be secured by any of a wide variety of known fasteners that will permit their removal for replacement. Also shown in FIG. 1 are a series of aligned baffles 40 that channel the water in close proximity to the surface of the tubes and also provide an opaque barrier and reflective surface to minimize the exposure of other components inside the housing to the UV radiation. The channeling of the water serves to increase the time of exposure for a given volume of moving water by reducing turbulent and random flow patterns.

In FIG. 1 and the embodiments described below, the means of circulating the water is illustrated as an on-board pump. As will be understood by those of ordinary skill in the art, the water can be circulated by an external pump and delivered by a pressurized flexible tube to the pool cleaner. The same principles and advantages of the invention will apply to such a system.

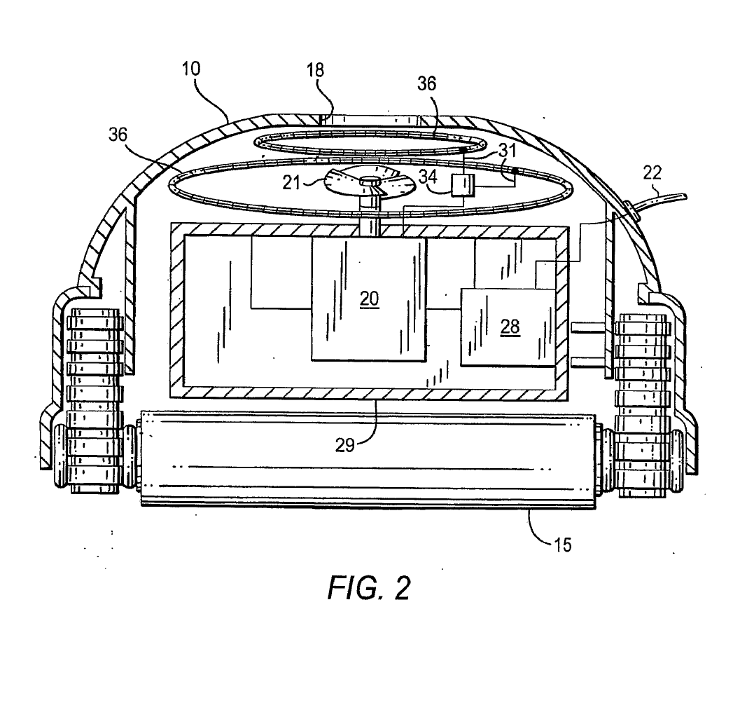

Referring now to FIG. 2, an alternative embodiment is illustrated in which two circular tubes 36 are secured to the internal surface of the pool cleaner. Again, a system of baffles can be provided to channel a portion of the water in close proximity to the tubes to enhance the bactericidal effect. The baffles also serve the purpose of minimizing exposure of the other internal components to UV radiation. It will be understood that a single tube 36 can be installed, or more than two tubes, depending upon the size of the unit, radiation emission level of the tubes, water flow characteristics and other factors that are within the skill of the art to determine.

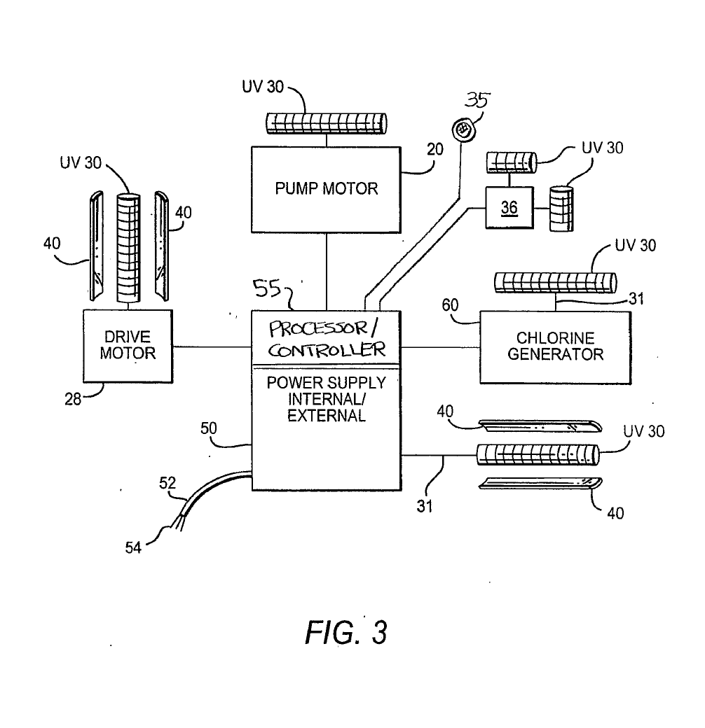

With reference to the schematic circuit diagram of FIG. 3, it will be seen that the power cord from the external power supply can alternatively include an additional conductor 23 for supplying power to the one or more UV tubes.

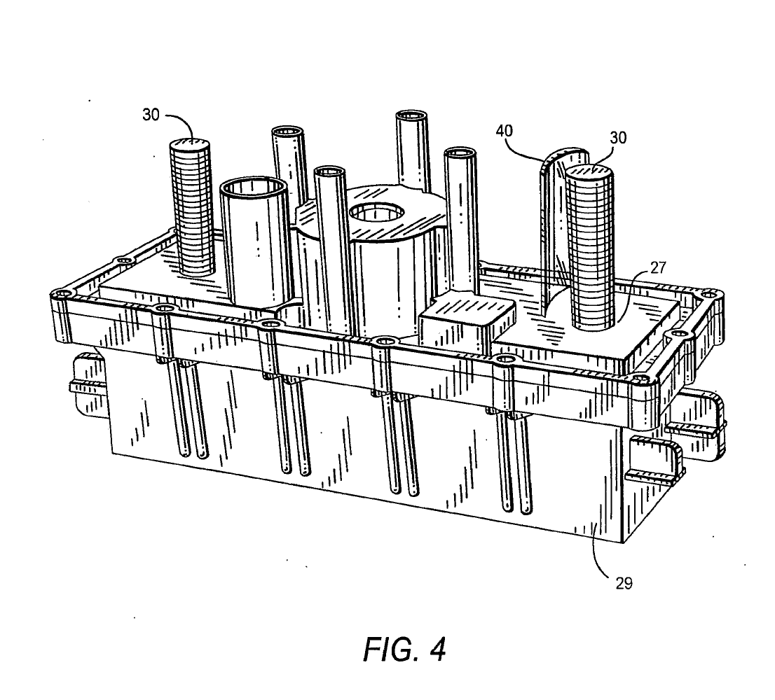

Referring now to the further embodiment illustrated in FIG. 4, two straight UV radiation tubes 30 are mounted directly on a surface of a waterproof drive motor housing 29. The ends of the tube can be fitted with electrical connectors and are inserted into appropriate socket recesses 27 formed in the housing 29. Electrical power is provided to the sockets from the interior leads of the housing. As will be apparent to those of ordinary skill in the art, all connections and conductor passages are waterproof.

As also shown in FIG. 4, a protective baffle 40 is mounted on the surface adjacent tube 30 in order to reduce the exposure of the adjacent molded plastic components projecting from the surface of the housing to UV radiation. It will be understood that baffles can be integrally formed during the original molding of the plastic parts comprising the housing.

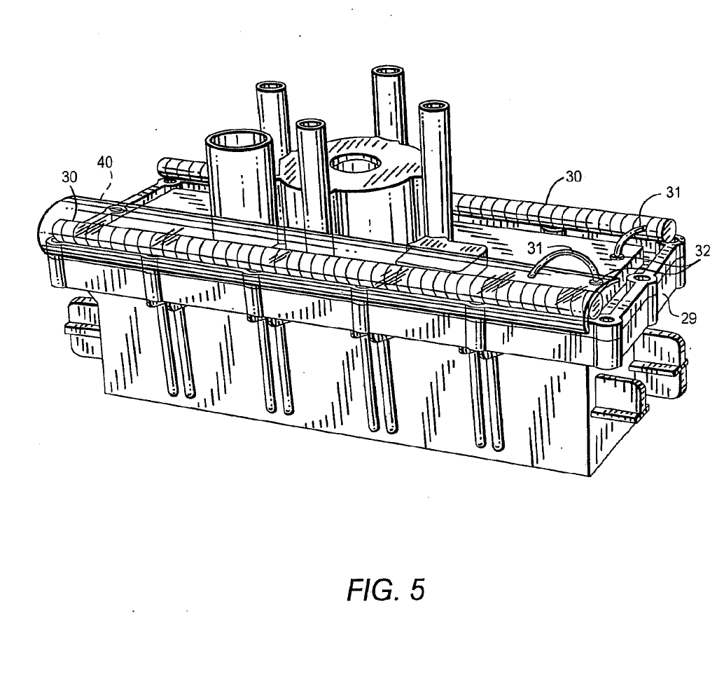

In a further related embodiment illustrated in FIG. 5, the elongated straight UV source tubes 30 are mounted on either side of the surface of the housing 29 and in close proximity. Electrical leads 31 extend from the end of the respective tubes through a sealed orifice 32 into the interior of the housing where they receive power.

As also shown in FIG. 5, a transparent baffle 40 is shown mounted in position to channel water from the sides of the housing 29 across the elongated surface of tubes 30.

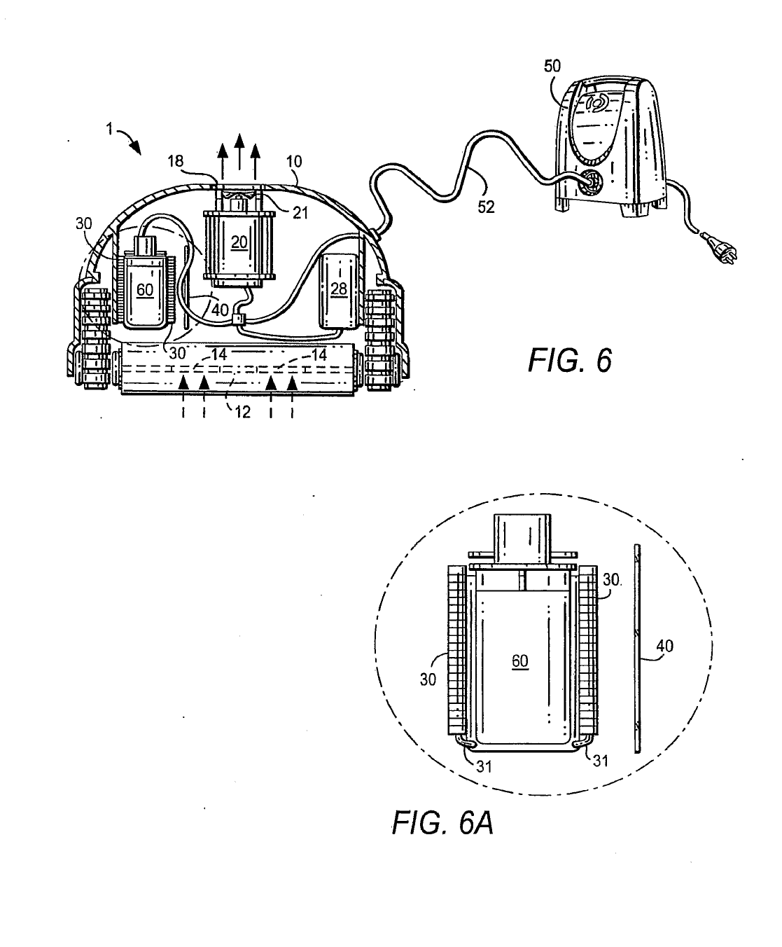

Referring now to FIGS. 6 and 6A, a further embodiment is illustrated in which a pair of UV radiation-emitting tubes 30 are mounted on the housing for an on-board chlorine generator 60. As in the earlier embodiments, the electrical conductors 31 are admitted to the interior of the chlorine generator housing where they are connected to a power source. A baffle 40 is provided on the right side, as shown in FIG. 6, to both channel the water rising through the pool cleaner housing in close proximity to the surface of tube 30 and to also provide a radiation barrier to reduce the exposure of other components to the potentially damaging radiation.

As will be understood from the previous disclosure, additional vertical tubes 30 can be similarly mounted on the drive motor housing 28 and on the pump motor housing 22 or other assembly fittings. The flow of water in the conventional pool cleaner illustrated is upwards through the baseplate and exiting through an outlet port in housing 10 located above the pump impeller 21. Thus, laminar flow past the one or more UV radiation-emitting tubes in this arrangement can be readily achieved by the use of baffles to maintain a given volume of water in relatively close proximity to the radiation source for a predetermined period of time. These flow rate determinations for exposure purposes are within the skill in the art.

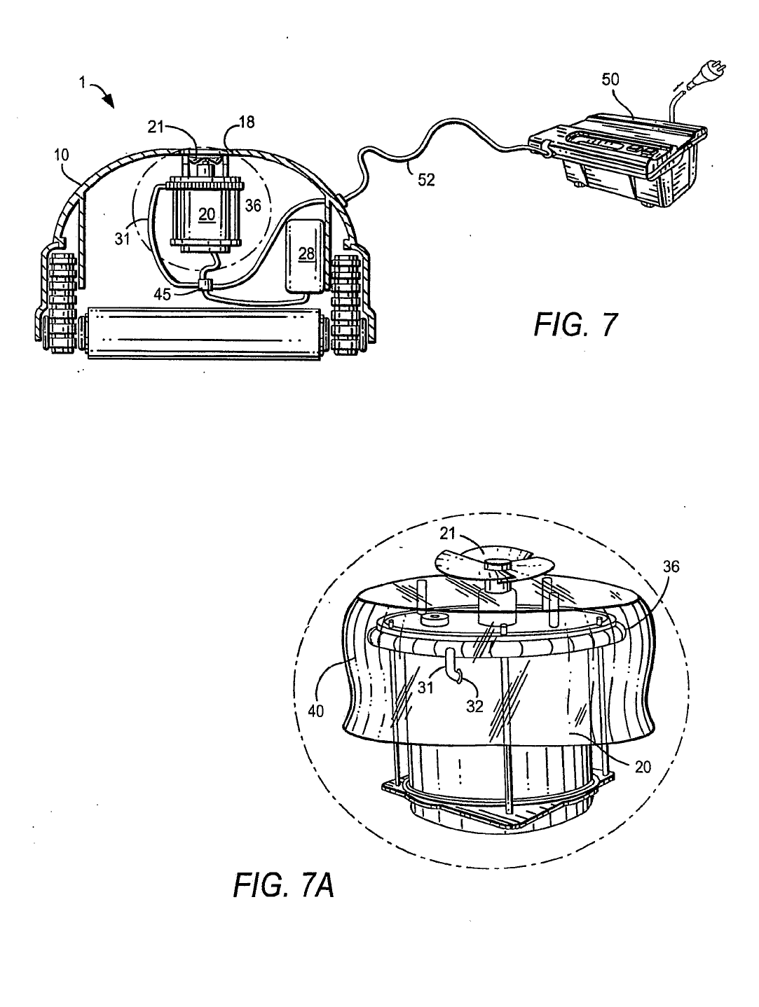

With reference to FIGS. 7 and 7A, there is illustrated another representative embodiment in which a circular tube 36 is mounted on the pump motor assembly. Additional circular tubes can be mounted at other positions on the pump motor assembly or, as illustrated in FIG. 2, on the interior surface of the pool cleaner housing.

As illustrated in FIG. 7A, one or more cylindrical baffles 40 can be positioned to provide a generally laminar flow in the vicinity of the tube 36. Depending upon the configuration of the outlet port and relative location of the tube 36 on the pump housing, a barrier to eliminate exposure to viewers in the vicinity of the pool cleaner through the outlet opening 18 can be installed as a safety measure.

As shown in the exploded view of FIG. 7A, the tube 36 is provided with conductor leads 31 that extend through a seal 36 in the waterproof pump housing where they are connected to the pump's power source. In the illustration of FIG. 7, the power is alternatively supplied via conductors attached to a waterproof junction box 45, which in turn receives power from the external power supply 50 via floating power cable 52.

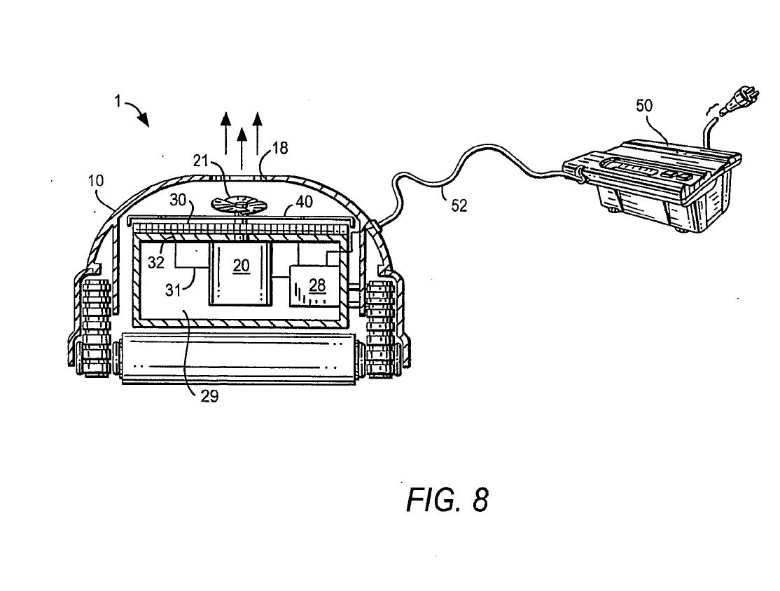

Referring to FIG. 8, a further illustration of the installation of the embodiment of FIG. 5 is shown. Power is provided by external source 50, via power cord 52. The UV radiation tube 30 receives its power from the pump motor 20. In this embodiment, when power to the pump is discontinued, the UV radiation also ceases

As will be apparent to those of ordinary skill in the art, the invention is equally adaptable to pool cleaners in which the source of pressurized water is provided by a remote pump and is delivered to the unit by a flexible hose that is secured to an inlet port in the housing.

The above descriptions and the specific embodiments are intended as illustrative of the method and apparatus of the invention. As will be apparent to those of ordinary skill in the art, various other modifications and arrangements can be undertaken without departing from the spirit of the invention, the scope of which is to be determined with reference to the claims that follow.

I claim:

1. A pool cleaning apparatus for cleaning the sidewalls and/or bottom of a swimming pool, the apparatus having an exterior housing and means for circulating water through the housing, characterized by at least one source of water-sterilizing UV radiation positioned in the interior space defined by the housing, whereby water passing in proximity to the UV radiation source is exposed to sterilizing radiation and the amount of any bacteria in the water is reduced.

2. The apparatus of claim 1 in which the at least one source of UV radiation is a straight tube or a circular tube, or a combination of straight and circular tubes.

3. The apparatus of claim 1 in which the source of UV radiation is secured to the interior surface of the housing.

4. The apparatus of claim 1 in which the source of UV radiation is secured to a functional component contained in the housing.

5. The apparatus of claim 1 which includes at least one baffle for channeling water in proximity to the radiation source.

6. The apparatus of claim 1 which includes at least one radiation barrier for interrupting the passage of radiation from the UV source.

7. The apparatus of claim 1 in which the radiation emitting source is not visible from the exterior of the pool cleaner housing.

8. A method of sterilizing water in a pool or tank through which a pool cleaner is moving, the pool cleaner having an exterior housing and a pump for moving water through the housing, the method comprising:
(a) positioning one or more UV radiation emitting devices in the interior space defined by the housing; and
(b) passing water in close proximity to the devices, whereby the amount of any active bacteria in the passing water is reduced as a result of exposure to the radiation.

9. The method of claim 8 in which the radiation is emitted only when the pump is activated to move water through the housing.

10. The method of claim 8 in which the pump is located inside the housing.
